(19) United States
(12) Patent Application Publication
(10) Pub. No.: US 2009/0087732 A1
(43) Pub. Date: Apr. 2, 2009

(54) SECONDARY BATTERY

(76) Inventor: Dae-Kyu KIM, Suwon-si (KR)

Correspondence Address: CHRISTIE, PARKER & HALE, LLP, PO BOX 7068, PASADENA, CA, 91109-7068, US

(21) Appl. No.: 12/209,972

(22) Filed: Sep. 12, 2008

(30) Foreign Application Priority Data
Sep. 27, 2007 (KR) 10-2007-0097343

(51) Int. Cl. H01M 2/02

(52) U.S. Cl. 429/176

(57) ABSTRACT

A secondary battery is provided including an electrode assembly having a positive electrode plate, a negative electrode plate, and a separator between the two plates. A can is provided for housing the electrode assembly, the can including depressions protruding inward from a side surface of the can, wherein the depressions contact an outer edge of the electrode assembly to prevent lateral movement of the electrode assembly within the can. A cap assembly is provided for sealing the can.

### CROSS-REFERENCE TO RELATED APPLICATION

This application claims priority to and the benefit of Korean Patent Application No. 10-2007-97343, filed Sep. 27, 2007, the entire content of which is incorporated herein by reference.

### BACKGROUND OF THE INVENTION

1. Field of the Invention

The present invention relates to a secondary battery, and more particularly, to a can for a secondary battery.

2. Discussion of the Related Art

In general, secondary batteries are rechargeable for repetitive use, unlike dry cells that can be no longer used when completely discharged. Secondary batteries are popular because they are compact and have a high capacity.

A low-capacity battery in a single cell battery pack is used for small portable electronic products, such as cellular phones, plasma display panels (PDPs), notebook computers, cameras, etc. On the other hand, a plurality of connected battery cells forming a high-capacity battery pack is widely used as a power supply for driving a motor in a hybrid vehicle, for example.

In particular, lithium secondary batteries are widely used in a variety of devices because they have an operation voltage of 3.6V and a better energy density per weight than nickel-cadmium batteries, nickel-metal hydride batteries, and other conventional batteries.

Lithium secondary batteries may be classified into can-type lithium secondary batteries and pouch-type lithium secondary batteries, depending on the shape of a housing that accommodates an electrode assembly. The can-type lithium secondary batteries may be further classified into prismatic lithium secondary batteries and cylindrical lithium secondary batteries. Also, the lithium secondary batteries may be classified into lithium-ion secondary batteries and lithium-polymer secondary batteries depending on type of electrolyte.

When a lithium secondary battery is overcharged, resistance increases due to electrolyte evaporating in the upper portion of an electrode assembly. The resistance of the upper portion of the electrode assembly generates heat, thereby increasing an internal temperature of the battery. In this case, internal pressure of the battery rapidly increases due to electrolyte additives such as cyclohexane benzene (CHB) and benzopyrene (BP) that are typically dissolved to generate a gas when the battery is overcharged.

To solve the aforementioned problems, in a conventional cylindrical secondary battery, when internal pressure of the battery increases above a threshold value or the battery is likely to explode due to overcharging or abnormal operation, a cap assembly interrupts a current flow in the battery so that the temperature no longer increases, resulting in improved stability.

The cylindrical secondary battery includes a can for housing an electrode assembly and electrolyte and a cap assembly coupled to an upper opening of the can via an insulating gasket. The electrode assembly consists of two rectangular plate-shaped electrodes and a separator between the electrodes for preventing a short-circuit between the two electrodes. The electrodes and the separator are wound in a jelly roll form.

Because the electrode assembly of the conventional secondary battery configured described above is inserted into the can, the electrode assembly may move inside the can upon to external impact, thus increasing internal resistance of the battery. The increased internal resistance consumes some voltage to be applied to the cell and obstructs full charge of the cell, degrading efficiency of the secondary battery.

The movement of the electrode assembly may disconnect an electrode tab from the electrode assembly, and the disconnected electrode tab may contact another conductor, which may establish an abnormal short-circuit and cause a safety issue.

### SUMMARY OF THE INVENTION

In accordance with the present invention, an exemplary embodiment provides a secondary battery having a can adapted to prevent relative movement between an electrode assembly within the can and the can itself. In one exemplary embodiment, a secondary battery is provided including an electrode assembly having a positive electrode plate, a negative electrode plate, and a separator between the two plates. A can is provided for housing the electrode assembly, the can including depressions protruding inward from a side surface of the can, wherein the depressions contact an outer edge of the electrode assembly to substantially prevent lateral movement of the electrode assembly within the can. A cap assembly is provided for sealing the can.

In one exemplary embodiment, the depressions are grooves. The depressions may be located corresponding to a position of the electrode assembly accommodated in the can. In exemplary embodiments, the depressions may have a semicircular cross-section, a triangular cross-section, or a rectangular cross-section. The depressions may extend longitudinally on a side surface of the can and/or they may extend along a circumference of the can. The depressions may be located symmetrically along the can. Further, the depressions may form rows and/or columns along the surface of the can, the depressions forming the rows and/or columns may be continuous or spaced from each other.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a cross-sectional view of a structure of a secondary battery according to an exemplary embodiment of the present invention.

FIG. 2 is an exploded perspective view of a secondary battery according to an exemplary embodiment of the present invention.

FIGS. 3A to 3C are cross-sectional views of various shapes of depressions formed in a can according to exemplary embodiments of the present invention.

FIGS. 4A to 4E are perspective views of various shapes of depressions in a can according to exemplary embodiments of the present invention.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein. Like reference numerals designate like elements throughout the specification.

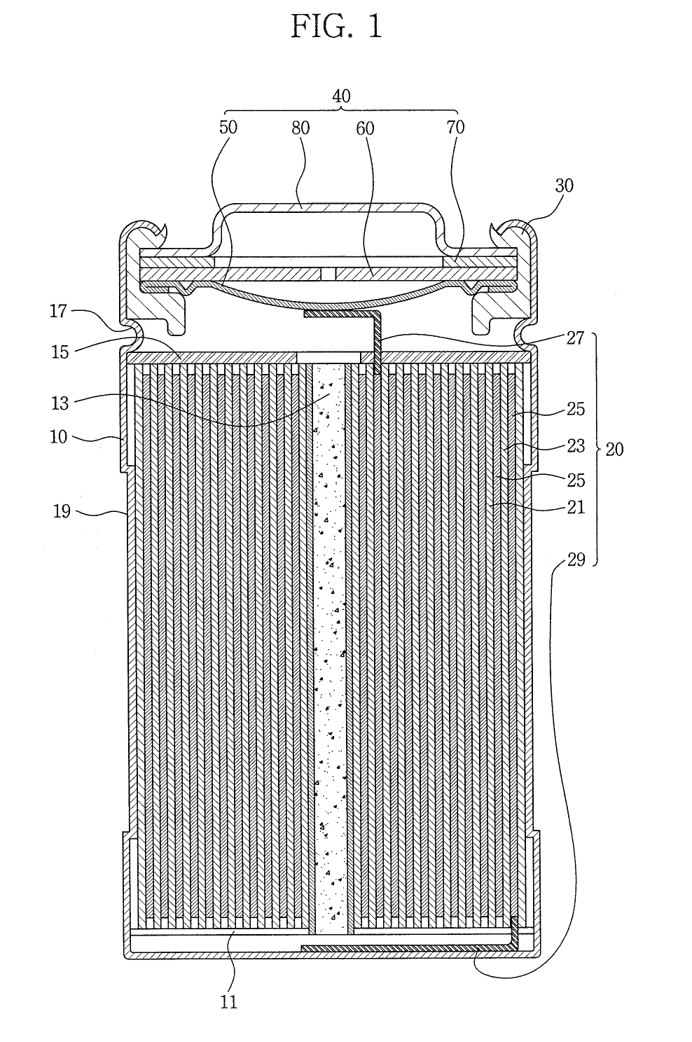

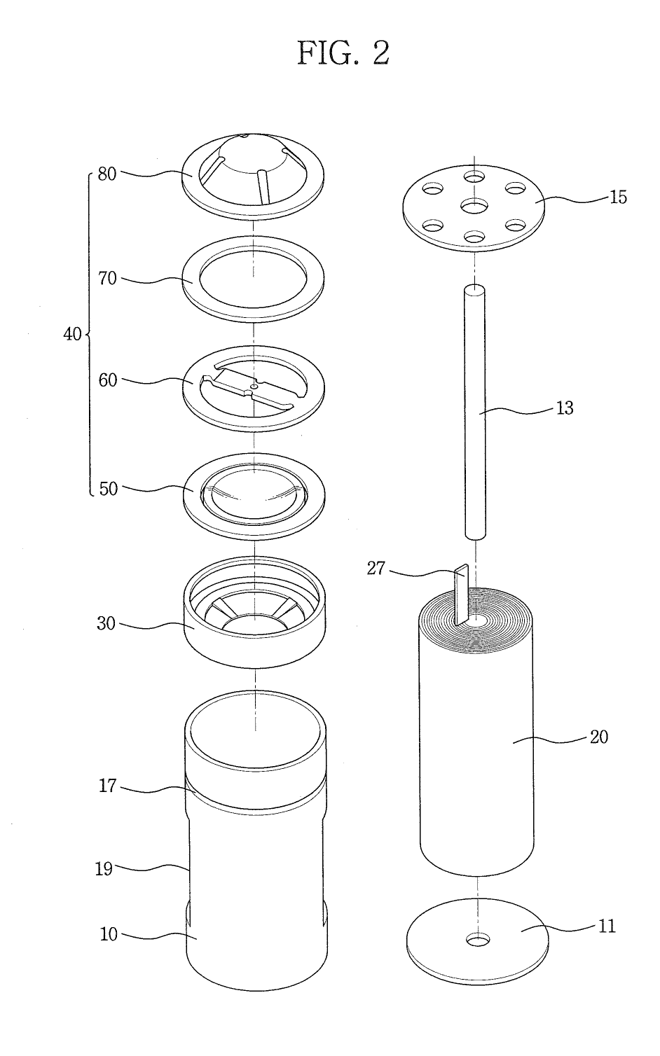

Referring to FIGS. 1 and 2, two electrodes 21, 23 formed in a rectangular plate shape are stacked and wound, resulting in a jelly roll type electrode assembly 20. Respective separators 25 are located between the two electrodes and on or beneath the electrodes to prevent a short circuit between the electrodes. Each of the electrodes 21, 23 is formed by coating a collector plate with positive electrode active material slurry or negative electrode active material slurry, and the collector plate is a metal foil or metal mesh made of aluminum or copper. The slurry is typically obtained by stirring a particulate active material, a subsidiary conductor, a binder and a plasticizer with solvent. The solvent will be removed in a subsequent electrode formation process.

A non-coating portion absent the slurry is formed in a portion of the collector in a winding direction of the electrode plates. Respective electrode tabs 27, 29 are disposed in the non-coating portions on the electrode plates. The electrode tab 27 is extended upward in a direction of an opening of the can 10 and the electrode tab 29 is extended downward.

The can 10 may be composed of an iron material, an aluminum alloy or the like in various shapes, including a cylindrical shape and a prismatic shape, and may be made by a deep drawing method. When the can 10 is formed in a cylindrical shape, it includes an open top end and a cylindrical side wall forming a cylindrical space to accommodate the electrode assembly. Additionally, a bottom surface is formed beneath the cylindrical side surface for covering a lower space of the cylindrical side wall.

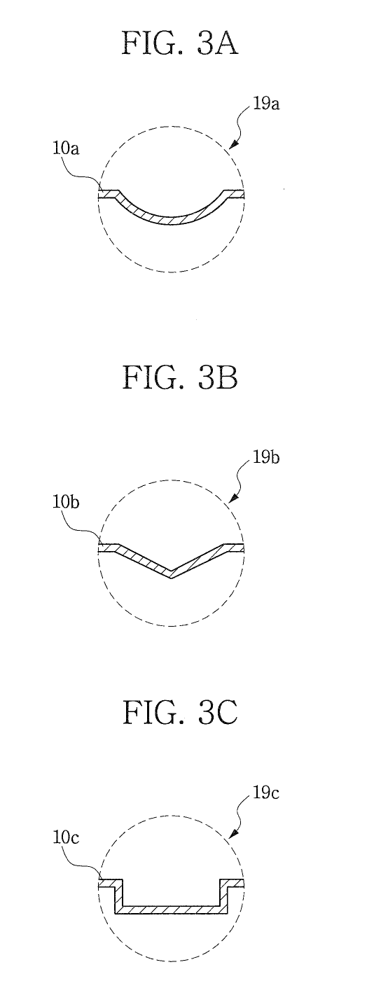

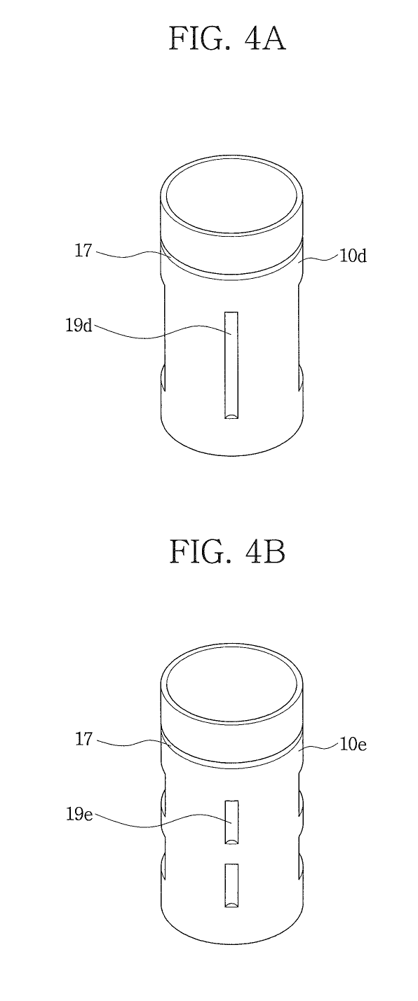

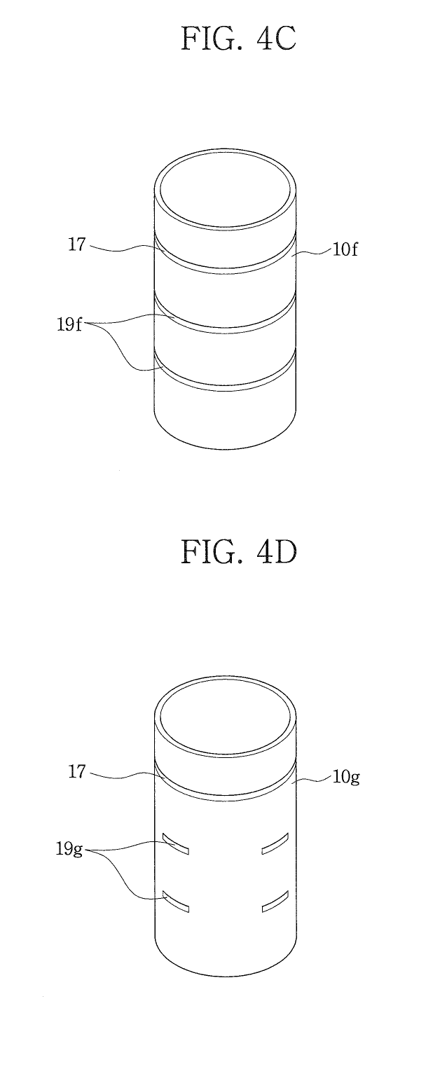

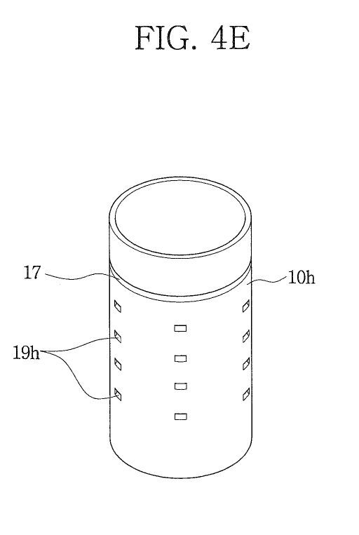

The can 10 further includes depressions 19 on the side surface. The depressions 19 have a surface in contact with an outer side surface of the electrode assembly 20 to prevent movement of the electrode assembly 20 inside the can 10. The depressions 19 will be described in greater detail with reference to FIGS. 3A to 4E.

The electrode assembly 20 is inserted into the can through the opening of the can 10. The bottom surface of the electrode assembly is covered with a lower insulating plate 11 prior to the insertion of the electrode assembly 20, and the electrode tab 29 extending downward from the electrode assembly 20 is bent to be parallel with the bottom surface of the can 10 while bypassing an outer side of the lower insulating plate 11. In one exemplary embodiment, the electrode assembly 20 is a cylindrical jelly roll, which has a central hollow.

The lower insulating plate 11 has a hole in an area corresponding to (i.e., aligned with) the hollow of the electrode assembly 20 and a portion of the bent electrode tab 29 crosses the hole of the lower insulating plate 11. A welding rod is inserted from through the hollow of the electrode assembly to weld the electrode tab 29 crossing the central hole to the bottom surface of the can 10. Accordingly, the can 10 has the same polarity as the lower electrode tab 29, so that the can itself serves as one electrode terminal.

In another exemplary embodiment, a central pin 13 may be provided to the can 10 and coupled in the hollow of the electrode assembly. The central pin 13 reduces the likelihood that the can 10 will be deformed by an external lateral force. The central pin 13 also serves as a passage along which a gas generated by the electrode assembly due to internal abnormality flows, and suppresses deformation of the electrode assembly caused by charging and discharging and by elapsed time, thereby increasing a lifetime of the battery.

After the downward electrode tab 29 is welded, an upper insulating plate 15 is positioned on the electrode assembly 20, and the upward electrode tab 27 of the electrode assembly 20 is extended outside the electrode assembly through a hole of the upper insulating plate 15.

A sidewall of the can is then bent inwardly adjacent an upper end of the electrode assembly or the upper insulating plate to form a bead 17. The bead 17 substantially prevents the electrode assembly from moving vertically inside the can even upon external impact, thereby maintaining a reliable electrical connection.

Electrolyte is then injected from the upper portion of the electrode assembly. In one exemplary embodiment, the electrolyte may be injected prior to formation of the bead. An insulating gasket 30 is provided on the can and a cap assembly is coupled with the can to seal the can. The insulating gasket 30 may be composed of an insulating elastic material for extending along an entire peripheral surface of the cap assembly 40. The insulating gasket 30 insulates the cap assembly 40 and the can 10, which have different polarities, and seals the can 10.

The cap assembly 40 may be disposed on the insulating gasket 30 pre-assembled, or the parts may be sequentially stacked on the gasket 30. The cap assembly 40 includes a vent 50 electrically connected to the electrode tab 27, a current interrupt device (CID) 60 activated by operation of the vent 50 to interrupt a current path, a positive temperature coefficient (PTC) thermistor 70, and a cap-up or protrusion 80 acting as an electrode terminal.

In embodiments of the present invention, the cap assembly 40 has a structure in which the cap-up 80 is positioned on the PTC 70, the CID 60 is positioned beneath the PTC thermistor 70, and the vent 50 is positioned beneath the CID 60. That is, the vent 50, the CID 60, the PTC thermistor 70, and the cap-up 80 are stacked sequentially.

When internal pressure is above a threshold level due to gas generated by the electrode assembly, the vent 50 activates the CID 60 to interrupt a flow of the current and exhausts the gas generated by the electrode assembly to the exterior. The can 10 is then crimped, in which pressure is applied inwardly and downwardly to walls of the opening of the cylindrical can 10 covered by the cap assembly 40 in the insulating gasket 30 in order to seal the can.

FIGS. 3A to 3C are cross-sectional views illustrating various shapes of depressions formed on the can according to exemplary embodiments of the present invention, and FIGS. 4A to 4E are perspective views illustrating various shapes of depressions on the can according to exemplary embodiments of the present invention.

Referring to FIGS. 3A to 3C, the depressions 19 formed inwardly on the side surface of the can 10 shown in FIGS. 1 and 2 may have various cross-sectional shapes, such as a semicircular shape 19a of a can 10a as shown in FIG. 3A, a triangular shape 19b of a can 10b as shown in FIG. 3B and a rectangular shape 19c of a can 10c as shown in FIG. 3C. As will be appreciated, the depressions are not limited to the shapes in the embodiment of the present invention, but rather may have other shapes selected by those skilled in the art. The depressions protrude inwardly to contact an edge of the electrode assembly for preventing movement of the electrode assembly inside the can.

The depressions formed on the can may include one or more depressions 19d, 19e formed longitudinally on the side surfaces of cans 10d, 10e, respectively, as shown in FIGS. 4A and 4B. Alternatively, the depressions may include one or more depressions 19f, 19g formed along an entire or a partial circumference of the side surfaces of cans 10f, 10g, respectively, as shown in FIGS. 4C and 4D. Alternatively, the depressions may include a plurality of depressions 19h formed at certain intervals on the side surface of can 10h, as shown in FIG. 4E.

It will be apparent to those skilled in the art that the depressions may be formed in other shapes. In one exemplary embodiment, the depressions are formed symmetrically so that the electrode assembly does not lean in one direction due to the presence of the depressions.

The depressions formed on the side surface of the can as described above may be grooves formed inwardly on the can by a mechanical method, such as rolling. The position of the depressions of the present invention are not limited, but in one exemplary embodiment, the depressions are formed on the side surface of the can corresponding to the position of the electrode assembly accommodated within the can to prevent movement of the electrode assembly.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A secondary battery comprising:
an electrode assembly including a positive electrode plate, a negative electrode plate, and a separator between the two plates;
a can for housing the electrode assembly, the can including depressions protruding inward from a side surface of the can; and
a cap assembly for sealing the can,
wherein the depressions contact an outer edge of the electrode assembly to prevent lateral movement of the electrode assembly within the can.

2. The secondary battery according to claim 1, wherein the depressions are grooves.

3. The secondary battery according to claim 1, wherein the depressions are located corresponding to a position of the electrode assembly in the can.

4. The secondary battery according to claim 1, wherein the depressions have a semicircular cross-section.

5. The secondary battery according to claim 1, wherein the depressions have a triangular cross-section.

6. The secondary battery according to claim 1, wherein the depressions have a rectangular cross-section.

7. The secondary battery according to claim 1, wherein the depressions extend longitudinally on a side surface of the can.

8. The secondary battery according to claim 7, wherein the depressions are located symmetrically on the can.

9. The secondary battery according to claim 1, wherein the depressions extend along a circumference of the can.

10. The secondary battery according to claim 9, wherein the depressions are located symmetrically on the can.

11. The secondary battery according to claim 9, wherein the depressions extend along an entire circumference of the can.

12. The secondary battery according to claim 9, wherein the depressions form at least two rows spaced along the can.

13. The secondary battery according to claim 12, wherein the at least two rows are continuous around an entire circumference of the can.

14. The secondary battery according to claim 7, wherein the depressions form at least two columns spaced along the can.

15. The secondary battery according to claim 14, wherein the depressions are spaced from each other along a longitudinal surface of the can.
